(19) United States
(12) Patent Application Publication
(10) Pub. No.: US 2015/0240054 A1
(43) Pub. Date: Aug. 27, 2015

(54) METHOD FOR MANUFACTURING RUBBER COMPOSITION

(71) Applicant: BRIDGESTONE CORPORATION, Tokyo (JP)

(72) Inventor: Masaaki Yamamoto, Kanagawa (JP)

(73) Assignee: BRIDGESTONE CORPORATION, Tokyo (JP)

(21) Appl. No.: 14/429,012

(22) PCT Filed: Aug. 6, 2013
(86) PCT No.: PCT/JP2013/071236

§ 371 Date: Mar. 18, 2015

(30) Foreign Application Priority Data
Sep. 20, 2012 (JP) 2012-207019

(51) Int. Cl. C08K 5/435; C08K 5/18

(52) U.S. Cl. CPC C08K 5/435; C08K 5/18

(57) ABSTRACT

The purpose of the present invention is to provide a rubber composition that can achieve improved ozone resistance and processing properties (scorch properties) in the rubber composition and that can be favorably used as an antivibration rubber material. A method for manufacturing a rubber composition by adding (A) N-phenyl-N-(trichloromethyl-thio)benzenesulfonamide and (B) an amine antioxidant to a rubber component primarily containing diene-based rubber, wherein the method for manufacturing a rubber composition is characterized in being separately provided with a step of mixing component raw materials containing component (A) and a step of mixing component raw materials containing component (B), whereby the mixing steps comprise at least two stages.

### TECHNICAL FIELD

The present invention relates to a method of producing rubber compositions for anti-vibration rubbers and the like that can be suitably used in high-temperature environments.

### BACKGROUND ART

The basic properties required of anti-vibration rubbers include strength properties for supporting a massive body such as an engine, and an anti-vibration performance which absorbs and suppresses vibrations from the body. In addition, when used in high-temperature environments such as engine compartments, anti-vibration rubbers are expected to possess excellent strength properties, a low dynamic-to-static modulus ratio and an excellent anti-vibration performance, and moreover are required to have an excellent heat resistance and compression set.

Research on compounding specific amounts of rubber components, crosslinking systems and other additives for anti-vibration rubbers in order to impart such collectively outstanding properties is actively underway, and numerous patent applications have already been filed. Of these many patent applications, some make deliberate use of bismaleimide compounds to improve the crosslinking system. For example, JP-A 3-258840 discloses rubber compounds of excellent heat resistance and a low dynamic-to-static modulus ratio that are obtained by adding sulfur, bismaleimide and a specific carbon black to a rubber component. In addition, the applicant earlier disclosed a rubber composition endowed with a low dynamic-to-static modulus ratio and excellent failure characteristics, heat resistance and durability by the inclusion of, as vulcanizing agents: sulfur, a specific sulfur compound, and a bismaleimide compound (JP-A 2010-254872).

However, even in this art, there remains room for improvement in the heat resistance and other properties of the anti-vibration rubber.

In addition, one test for evaluating anti-vibration rubbers is an ozone deterioration test in which the state of deterioration at a rubber surface in ozone-containing air, i.e., the presence or absence of ozone cracking, is investigated. This test is used to determine the durability of rubber in an ozone environment. However, in the foregoing prior-art, there remains room for improvement in the ozone resistance.

### CITATION LIST

### Patent Documents

Patent Document 1: JP-A H03-258840

Patent Document 2: JP-A 2010-254872

### SUMMARY OF INVENTION

### Technical Problem

It is therefore an object of the present invention to provide a method of producing rubber compositions in which the rubber properties can be further improved, and which enables improvements to be made to, in particular, the ozone resistance and also the processability of the composition during production.

### Solution to Problem

The inventor has conducted extensive investigations in order to achieve the above objects and has earlier proposed, in the previously disclosed rubber composition of Japanese Patent Application No. 2011-123049, an anti-vibration rubber composition which is composed primarily of a diene rubber and contains N-phenyl-N-(trichloromethylthio)benzenesulfonamide and an amine-type antioxidant. However, the inventor has found that there remains room for improvement in the ozone resistance and processability (scorch resistance) of this rubber composition. The reason is that the N-phenyl-N-(trichloromethylthio)benzenesulfonamide and the amine-type antioxidant readily react. The reaction mechanism has not been fully elucidated such as through analysis and is not well understood, although it has been found that when the content of N-phenyl-N-(trichloromethylthio)benzenesulfonamide is increased, the amount of decrease in the amine-type antioxidant becomes larger. Hence, the inventor has discovered that by adding the N-phenyl-N-(trichloromethyl-thio)benzenesulfonamide and the amine-type antioxidant in separate mixing steps, chemical reactions between both ingredients can be held to a minimum and that, as a result, it is possible to improve the ozone resistance and also the processability (scorch resistance) of the rubber composition.

Accordingly, this invention provides the following method of producing rubber compositions.

[1] A method of producing a rubber composition by adding (A) N-phenyl-N-(trichloromethylthio)benzenesulfonamide and (B) an amine-type antioxidant to a rubber component composed primarily of a diene rubber, the method being characterized by separately providing the step of mixing in a component raw material containing component (A) and the step of mixing in a component raw material containing component (B), such that mixing is carried out in at least two stages.
[2] The rubber composition producing method of [1], wherein the step of mixing in the component raw material containing component (A) is a later step than the step of mixing in the component raw material containing component (B).
[3] The rubber composition producing method of [1] or [2], wherein the amine-type antioxidant of component (B) has the following chemical structure

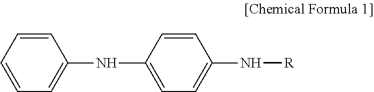

(R being a hydrocarbon group of from 1 to 8 carbons that is linear, branched, cyclic or a combination thereof).
[4] The rubber composition producing method of [1], [2] or
[3], wherein the rubber composition is adapted for use in anti-vibration rubber.

### Advantageous Effects of Invention

This invention, by adding (A) N-phenyl-N-(trichloro-methylthio)benzenesulfonamide and (B) an amine-type antioxidant in separate mixing steps to a rubber component composed primarily of a diene rubber, enables chemical reactions between both ingredients to be kept to a minimum. As a result, the processability (scorch resistance) and ozone resistance of the rubber composition can be improved, making the composition suitable for use as an anti-vibration rubber material.

### DESCRIPTION OF EMBODIMENTS

The rubber composition used in the production method of the invention is described below.

The rubber component used in the inventive method of producing rubber compositions is composed primarily of a diene rubber. Illustrative examples of the diene rubber include, but are not particularly limited to, natural rubber (NR), isoprene rubber (IR), butadiene rubber (BR), styrene-butadiene rubber (SBR) and acrylonitrile-butadiene rubber (NBR). Any one of these may be used alone, or two or more may be used in admixture. In this invention, the use of natural rubber (NR), isoprene rubber (IR) or butadiene rubber (BR) is especially preferred.

Rubbers other than the diene rubber may also be included in the rubber component. Examples of such rubbers include acrylic rubber and ethylene-propylene rubber (EPDM).

The rubber composition of the invention includes, as component (A), N-phenyl-N-(trichloromethylthio)benzene-sulfonamide having the chemical structure shown below. In the present invention, including this substance makes it possible to obtain a rubber composition that is outstanding in terms of all of the following: heat resistance, compression set, dynamic-to-static modulus ratio, low-temperature properties and processability (scorch resistance), improvements to which have not been achievable by relying solely on the ratio of sulfur to vulcanization accelerator that has hitherto been adjusted or on the type of vulcanization accelerator.

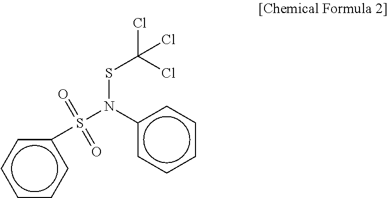

The content of N-phenyl-N-(trichloromethylthio)benzene-sulfonamide is preferably from 0.2 to 4 parts by weight per 100 parts by weight of the rubber component. If the content departs from this range, improvements in heat resistance, compression set, dynamic-to-static modulus ratio, low-temperature properties and processability (scorch resistance) may not be observed.

The N-phenyl-N-(trichloromethylthio)benzenesulfonamide is exemplified by the product available under the trade name “Vulkalent E/C” from Lanxess AG.

The rubber composition of the invention includes, as component (B), an amine-type antioxidant. The content of the amine-type antioxidant per 100 parts by weight of the rubber component is generally from 0.5 to 10 parts by weight, and preferably from 1 to 7 parts by weight. The amine-type antioxidant may be of one type or a combination of two or more types, and may be used in combination with another antioxidant such as a phenol-type antioxidant or an imidazole-type antioxidant.

Component (B) is not particularly limited, although an aromatic secondary amine-type antioxidant is preferred, especially one having the following chemical structure:

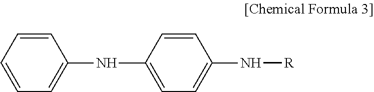

(wherein R is a hydrocarbon group of from 1 to 8 carbons that is linear, branched, cyclic or a combination thereof).

An example of an aromatic secondary amine-type antioxidant having three carbons is N-phenyl-N′-isopropyl-p-phenylenediamine (such as “Nocrac 810NA” from Ouchi Shinko Chemical Industry Co., Ltd.). An example of an aromatic secondary amine-type antioxidant having six carbons is N-phenyl-N′-(1,3-dimethylbutyl)-p-phenylenediamine (such as “Nocrac 6C” from Ouchi Shinko Chemical Industry Co., Ltd.). An example of an aromatic secondary amine-type antioxidant having eight carbons is N-phenyl-N′—(e.g., 1-methylheptyl)-p-phenylenediamine (such as “Nocrac 8C” from Ouchi Shinko Chemical Industry Co., Ltd.).

In this invention, a bismaleimide compound may be used as one accelerator. Examples of bismaleimide compounds include, but are not particularly limited to,
N,N′-o-phenylenebismaleimide, N,N′-m-phenylenebismaleimide,
N,N′-p-phenylenebismaleimide,
4,4′-methanebis(N-phenylmaleimide),
2,2-bis[4-(4-maleimidophenoxy)phenyl]propane and
bis(3-ethyl-5-methyl-4-maleimidophenyl)methane.
   In this invention, preferred use can be made of
N,N′-m-phenylenebismaleimide and
4,4′-methanebis(N-phenylmaleimide).

The bismaleimide compound may be of one type used alone or may be of two or more types used in combination. The content thereof is preferably set to from 1.0 to 5.0 parts by weight per 100 parts by weight of the diene rubber. At a bismaleimide compound content of less than 1.0 part by weight, the heat resistance, compression set and other properties may worsen. On the other hand, at a content of more than 5.0 parts by weight, the tensile properties (elongation, strength), durability and the like may worsen.

A vulcanization accelerator may be used in the rubber composition of the invention. The vulcanization accelerator is exemplified by, but not particularly limited to, benzothiazole-type vulcanization accelerators such as 2-mercaptobenzothiazole, dibenzothiazyl disulfide, N-cyclohexyl-2-benzothiazyl sulfenamide, N-t-butyl-2-benzothiazyl sulfenamide and N-t-butyl-2-benzothiazyl sulfenamide; guanidine-type vulcanization accelerators such as diphenylguanidine; thiuram-type vulcanization accelerators such as tetramethylthiuram disulfide, tetraethylthiuram disulfide, tetrabutylthiuram disulfide, tetradodecylthiuram disulfide, tetraoctylthiuram disulfide, tetrabenzylthiuram disulfide and dipentamethylenethiuram tetrasulfide; dithiocarbamic acid salts such as zinc dimethyldithiocarbamate; and zinc dialkyldithiophosphates.

The vulcanization accelerator may be of one type, such as a sulfenamide type, a thiuram type, a thiazole type, a guanidine type or a dithiocarbamic acid salt type, or may be a combination of two or more such types. In order to, for example, adjust the vulcanization behavior (rate), it is preferable to use a combination of a thiuram-type and/or a thiazole-type vulcanization accelerator having a relatively high vulcanization accelerating ability with a guanidine-type and/or a sulfenamide-type vulcanization accelerator having a relatively moderate to low vulcanization accelerating ability. Specific examples include the combination of tetramethylthiuram disulfide with N-cyclohexyl-2-benzothiazyl sulfenamide, the combination of tetrabutylthiuram disulfide with N-t-butyl-2-benzothiazyl sulfenamide, and the combination of dibenzothiazyl disulfide with diphenylguanidine. The combination of vulcanization accelerators is not limited to the above combinations. The total amount of vulcanization accelerator included per 100 parts by weight of the rubber component is preferably from 0.2 to 10 parts by weight.

Sulfur may or may not be included in the rubber composition of the invention. However, including sulfur enables, in relative terms, even further improvement to be achieved in the properties of the rubber. When sulfur is included, the sulfur content per 100 parts by weight of the rubber component is preferably from 0.2 to 1.5 parts by weight, and more preferably from 0.2 to 1.0 part by weight. A sulfur content in excess of 1.5 parts by weight may invite a worsening of the heat resistance, compression set and processing stability.

In this invention, a vulcanization co-accelerator such as zinc white (ZnO) or a fatty acid may be included to help promote vulcanization. The fatty acid may be a linear or branched fatty acid that is saturated or unsaturated. The number of carbons on the fatty acid is not particularly limited, although a fatty acid of from 1 to 30 carbons, and preferably from 15 to 30 carbons, is advantageous. Specific examples include naphthenic acids such as cyclohexanoic acid (cyclohexanecarboxylic acid) and alkylcyclopentanes having side chains; saturated fatty acids such as hexanoic acid, octanoic acid, decanoic acid (including branched carboxylic acids such as neodecanoic acid), dodecanoic acid, tetradecanoic acid, hexadecanoic acid and octadecanoic acid (stearic acid); unsaturated fatty acids such as methacrylic acid, oleic acid, linoleic acid and linolenic acid; and resin acids such as rosin, tall oil acids and abietic acid. These may be used singly, or two or more may be used in combination. In this invention, preferred use can be made of zinc white and stearic acid. The content of these co-accelerators per 100 parts by weight of the rubber component is preferably from 1 to 10 parts by weight, and more preferably from 2 to 7 parts by weight. A content greater than 10 parts by weight may lead to a poor workability and a poor dynamic-to-static modulus ratio, whereas a content of less than 1 part by weight may retard vulcanization.

A known oil may be used. Examples include, without particular limitation, process oils such as aromatic oils, naphthenic oils and paraffinic oils; vegetable oils such as coconut oil; synthetic oils such as alkylbenzene oils; and castor oil. In this invention, the use of naphthenic oils is preferred. These may be used singly or two or more may be used in combination. The oil content per 100 parts by weight of the rubber component, although not particularly limited, may be set to generally from 2 to 80 parts by weight. At a content outside of this range, the kneading workability may worsen. When oil-extended rubber is used in the rubber component, the oil included in the rubber should be adjusted such that the combined amount of such oil and any oils that are separately added during mixing falls within the above range.

A known carbon black may be used. Examples include, without particular limitation, carbon blacks such as FEF, SRF, GPF, HAF, ISAF, SAF, FT and MT. In this invention, preferred use may be made of FEF. These carbon blacks may be used singly or two or more may be used in combination. The content of these carbon blacks per 100 parts by weight of the rubber component may be set to generally from 15 to 80 parts by weight, and preferably from 20 to 60 parts by weight. At a content of more than 80 parts by weight, the workability may worsen. On the other hand, at a content of less than 15 parts by weight, the adhesion may worsen.

Where necessary, additives commonly used in the rubber industry, such as waxes, antioxidants, fillers, blowing agents, plasticizers, oils, lubricants, tackifiers, petroleum-based resins, ultraviolet absorbers, dispersants, compatibilizing agents, homogenizing agents and vulcanization retardants, may be suitably included in the rubber component, provided the use of these additives does not detract from the objects of the invention.

With regard to the method of compounding the various above ingredients in the rubber composition manufacturing method of the invention, the processing stability (scorch stability) and ozone resistance can be improved by optimizing the mixing procedure for the rubber composition containing (A) N-phenyl-N-(trichloromethylthio)benzenesulfonamide and (B) an amine-type antioxidant. That is, the manufacturing method of the invention is characterized by separately providing the step of mixing in a component raw material containing above component (A) and the step of mixing in a component raw material containing above component (B), such that mixing is carried out in at least two stages.

In this invention, mixing is carried out by adding the various ingredients in two, three or more separate stages. A known mixer such as a kneader, roll mill, internal mixer or Banbury mixer may be used for mixing. During such use, it is possible to employ the same mixer, or to employ various devices in combination. For example, it is possible to carry out first-stage mixing with a kneader and to carry out second-stage mixing with a device other than a kneader (e.g., a Banbury mixer).

As described above, this invention is characterized by separately providing the step of mixing in a component raw material containing component (A) and the step of mixing in a component raw material containing component (B). By thus adding the two rubber chemicals at different times, chemical reactions between the two rubber chemicals can be suppressed, as a result of which rubber properties such as ozone resistance can be improved. Moreover, in this invention, although the order of addition is not particularly limited, in order to be able to improve not only the ozone resistance but also the processability (scorch resistance), it is preferable to have the step of mixing in a component raw material containing component (A) be a later step than the step of mixing in a component raw material containing component (B).

With regard to the mixing conditions for the rubber composition, either the time or the temperature may be used alone or both may be used in combination. Specifically, in this invention, in the step of mixing in a component raw material containing component (A), the rubber chemicals (ingredients of the raw material) can be mixed in over a total mixing time of from 60 to 1,800 seconds and at a mixing temperature of from 40 to 180° C. And in the step of mixing in a component raw material containing component (B), the rubber chemicals (ingredients of the raw material) can be mixed in over a total mixing time of from 60 to 1,800 seconds and at a mixing temperature of from 30 to 150° C.

When the rubber composition produced as described above is cured to a predetermined shape, the vulcanization conditions are not particularly limited and depend also on the intended use of the rubber composition. For example, in the case of anti-vibration rubbers, vulcanization conditions of 140 to 180° C. and 5 to 120 minutes can generally be used. A known forming machine such as an extruder or a press may be used to form the rubber composition into a sheet, strip or the like.

Uses for the above rubber compositions are not particularly limited, although they can be suitably used as rubber compositions for anti-vibration rubbers required to have good properties such as heat resistance, ozone resistance and compression set, and especially as rubber compositions for anti-vibration rubbers to be used in automotive parts such as torsional dampers, engine mounts and muffler hangers.

### EXAMPLES

The invention is illustrated more fully below by way of Working Examples and Comparative Examples, although these Examples do not limit the invention.

As shown in Table 1 below, when mixing in the rubber chemicals, the mixing operation was divided into an A mixing step and a B mixing step, and the rubber compositions for anti-vibration rubbers in Working Examples 1 to 4 and Comparative Examples 1 to 4 were produced. The apparatus used during mixing was a Banbury mixer. In the A mixing step, a base rubber (base polymer) was mixed for about 20 seconds, then the other A mixing step rubber chemicals were charged into the mixer and mixed for about 120 seconds, after which the rubber chemicals in the A mixing step were discharged at from 80 to 130° C. Next, the rubber obtained in the A mixing step was charged into the mixer and mixed for about 60 seconds, then the B mixing step rubber chemicals were charged and mixed for about 90 seconds, after which the mixed rubber in the A mixing and the B mixing steps was discharged at from 80 to 120° C.

The rubber compositions for anti-vibration rubbers of above Working Examples 1 to 4 and Comparative Examples 1 to 4 were each vulcanized and cured to a given shape under given conditions, thereby producing shaped products. These shaped products were prepared as test specimens for evaluating the anti-vibration rubbers of the invention, and evaluations of the processing stability (scorch stability) and ozone resistance were carried out. The results are presented in Table 1.

### [Processing Stability (Scorching Stability)/Curelastometer]

The rubber compositions to be evaluated were vulcanized at 165° C. and measured in accordance with JIS K 6300 (Physical Test Methods for Unvulcanized Rubber). The T(10) values were measured and are shown in the table as indices based on an arbitrary value of 100 for the T(10) time in Comparative Example 1. A larger index represents a better scorching resistance. Here, T(10) signifies the onset of vulcanization, and so this was treated as the scorching time.

### [Ozone Resistance/Dynamic Ozone Deterioration Test]

Evaluation was carried out in accordance with JIS K 6259 (Dynamic Ozone Deterioration Test). The test conditions were set to an ozone concentration of 50 pphm, a temperature of 40° C., and a tensile strain of 20%, and the time until ozone cracking arises at the rubber surface when the test is conducted was treated as an indicator of the ozone resistance. A higher value represents a better ozone resistance. These values are shown in the table as indices based on an arbitrary value of 100 for the time until cracking arose in Comparative Example 1.

The compounding ingredients are described in detail below.

### Rubber Component

Natural rubber (NR): RSS#4
Butadiene rubber (BR): “BR01” from JSR Corporation

### Carbon Black

FT carbon black was used: “Asahi Thermal” from Asahi Carbon Co., Ltd.
FEF carbon black was used: “Asahi #65” from Asahi Carbon Co., Ltd.

### Stearic Acid

“Stearic Acid 50S” from New Japan Chemical Co., Ltd.

### Zinc White

Available as “No. 3 Zinc White” (Hakusui Tech Co., Ltd.)

### Wax

Available under the trade name “Suntight S” (Seiko Chemical Co., Ltd.)

### Antioxidant: RD

2,2,4-Trimethyl-1,2-dihydroquinoline polymer, available as “Nocrac 224” from Ouchi Shinko Chemical Industry Co., Ltd.

### Antioxidant: 6C

N-Phenyl-N′-(1,3-dimethylbutyl)-p-phenylenediamine, available as “Nocrac 6C” from Ouchi Shinko Chemical Industry Co., Ltd.

### Microcrystalline Wax

Available as “Suntight S” from Seiko Chemical Co., Ltd.

### Naphthenic Oil

“Sunthene 4240” from Sun Refining and Marketing Company

### N-Phenyl-N-(trichloromethylthio)benzenesulfonamide

“Vulkalent E/C” from Lanxess AG

### Sulfur

Available as “Sulfur Powder” from Tsurumi Chemical
   N,N′-m-Phenylenebismaleimide
Available as “Vulnoc PM” from Ouchi Shinko Chemical Industry Co., Ltd.

### 4,4′-Methanebis(N-phenylmaleimide)

Available as “BMI-RB” from Daiwa Kasei Industry Co., Ltd.

### Vulcanization Accelerator TT

Available under the trade name “Accel TMT-PO” (Kawaguchi Chemical Industry Co., Ltd.)

### Vulcanization Accelerator CZ

Available under the trade name “Nocceler CZ-G” (Ouchi Shinko Chemical Industry Co., Ltd.)

TABLE 1

| Rubber formulation | Mixing/ | Comparative | Comparative | | | Comparative | Comparative | | |
|---|---|---|---|---|---|---|---|---|---|
| (pbw) | charging | Example 1 | Example 2 | Example 1 | Example 2 | Example 3 | Example 4 | Example 3 | Example 4 |
| NR | A | 100.0 | 100.0 | 100.0 | 100.0 | 80.0 | 80.0 | 80.0 | 80.0 |
| BR | | | | | | 20.0 | 20.0 | 20.0 | 20.0 |
| FT CB | | | | | | 50.0 | 50.0 | 50.0 | 50.0 |
| FEF CB | | 30.0 | 30.0 | 30.0 | 30.0 | | | | |
| Stearic acid | | 2.0 | 2.0 | 2.0 | 2.0 | 2.0 | 2.0 | 2.0 | 2.0 |
| Zinc white | | 3.0 | 3.0 | 3.0 | 3.0 | 3.0 | 3.0 | 3.0 | 3.0 |
| Wax | | 1.0 | 1.0 | 1.0 | 1.0 | 1.0 | 1.0 | 1.0 | 1.0 |
| Antioxidant RD | | 1.0 | 1.0 | 1.0 | 1.0 | 1.0 | 1.0 | 1.0 | 1.0 |
| Antioxidant 6C | | 3.0 | | 3.0 | | 3.0 | | 3.0 | |
| Microcrystalline | | 2.0 | 2.0 | 2.0 | 2.0 | 2.0 | 2.0 | 2.0 | 2.0 |
| wax | | | | | | | | | |
| Naphthenic oil | | 8.0 | 8.0 | 8.0 | 8.0 | 5.0 | 5.0 | 5.0 | 5.0 |
| N-Phenyl-N-(tri- | | 2.0 | | | 2.0 | 2.0 | | | 2.0 |
| chloromethylthio)- | | | | | | | | | |
| benzene- | | | | | | | | | |
| sulfonamide | | | | | | | | | |
| Sulfur | B | 0.75 | 0.75 | 0.75 | 0.75 | 0.75 | 0.75 | 0.75 | 0.75 |
| N,N′-m-Phenylene- | | | | | | 3.0 | 3.0 | 3.0 | 3.0 |
| bismaleimide | | | | | | | | | |
| 4,4′-Methanebis- | | 3.0 | 3.0 | 3.0 | 3.0 | | | | |
| (N-phenylmale- | | | | | | | | | |
| imide) | | | | | | | | | |
| Vulcanization | | 1.5 | 1.5 | 1.5 | 1.5 | 1.5 | 1.5 | 1.5 | 1.5 |
| accelerator TT | | | | | | | | | |
| Vulcanization | | 1.5 | 1.5 | 1.5 | 1.5 | 1.5 | 1.5 | 1.5 | 1.5 |
| accelerator CZ | | | | | | | | | |
| Antioxidant 6C | | | 3.0 | | 3.0 | | 3.0 | | 3.0 |
| N-Phenyl-N- | | | 2.0 | 2.0 | | | 2.0 | 2.0 | |
| (trichloromethyl- | | | | | | | | | |
| thio)benzene- | | | | | | | | | |
| sulfonamide | | | | | | | | | |

| | | | | | | | | |
|---|---|---|---|---|---|---|---|---|
| Processing stability/ | 100 | 105 | 112 | 105 | 110 | 115 | 123 | 115 |
| Curelastometer (165° C.) T₁₀ | | | | | | | | |
| (INDEX) | | | | | | | | |
| Ozone resistance/ | 100 | 100 | 150 | 145 | 100 | 100 | 160 | 150 |
| Time until cracking arises | | | | | | | | |
| (INDEX) | | | | | | | | |

The following is apparent from the results in Table 1. The rubber compounding ingredients and contents thereof are the same in both Example 1 and Comparative Example 1, but because N-phenyl-N-(trichloromethylthio)benzenesulfonamide and the amine-type antioxidant (6C) in Example 1 were mixed in at different stages, improvements in the processing stability and the ozone resistance can be seen. The rubber compounding ingredients and contents thereof are the same in both Example 2 and Comparative Example 2, but because N-phenyl-N-(trichloromethylthio)benzenesulfonamide and the amine-type antioxidant (6C) in Example 2 were mixed in at different stages, an improvement in the ozone resistance can be seen. The rubber compounding ingredients and contents thereof are the same in both Example 3 and Comparative Example 3, but because N-phenyl-N-(trichloromethylthio)-benzenesulfonamide and the amine-type antioxidant (6C) in Example 3 were mixed in at different stages, improvements in the processing stability and ozone resistance can be seen. The rubber compounding ingredients and contents thereof are the same in both Example 4 and Comparative Example 4, but because N-phenyl-N-(trichloromethylthio)benzenesulfonamide and the amine-type antioxidant (6C) in Example 4 were mixed in at different stages, an improvement in the ozone resistance can be seen.

1-4. (canceled)

5. A method of producing a rubber composition comprising the steps of:
mixing in a component raw material containing (A) N-phenyl-N-(trichloromethylthio)benzenesulfonamide and
mixing in a component raw material containing (B) an amine-type antioxidant, wherein the mixing is separately carried out in at least two stages, thereby to obtain the rubber composition adding by component (A) and component (B) to a rubber component composed primary of a diene rubber.

6. The rubber composition producing method of claim 5, wherein the step of mixing in the component raw material containing component (A) is a later step than the step of mixing in the component raw material containing component (B).

7. The rubber composition producing method of claim 5, wherein the amine-type antioxidant of component (B) has the following chemical structure 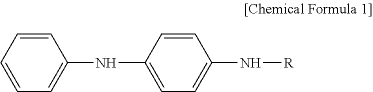
(R being a hydrocarbon group of from 1 to 8 carbons that is linear, branched, cyclic or a combination thereof).

8. The rubber composition producing method of claim 5, wherein the rubber composition is adapted for use in anti-vibration rubber.
